(19) United States
(12) Patent Application Publication
(10) Pub. No.: US 2024/0393020 A1
(43) Pub. Date: Nov. 28, 2024

(54) LOW-PRESSURE BOILING COOLING SYSTEM

(71) Applicant: AGENCY FOR DEFENSE DEVELOPMENT, Daejeon (KR)

(72) Inventors: Sooin LEE, Sejong-si (KR); Seonghyun PARK, Daejeon (KR); Seung Il BAEK, Daejeon (KR)

(73) Assignee: AGENCY FOR DEFENSE DEVELOPMENT, Daejeon (KR)

(21) Appl. No.: 18/519,495

(22) Filed: Nov. 27, 2023

(30) Foreign Application Priority Data
May 26, 2023 (KR) 10-2023-0068073

(51) Int. Cl. F25B 23/00; F25B 45/00; H01M 8/04007

(52) U.S. Cl. CPC F25B 23/006; F25B 45/00; H01M 8/04059; F25B 2333/007; F25B 2400/23

(57) ABSTRACT

A low-pressure boiling cooling system is provided. The low-pressure boiling cooling system includes a sealed chamber containing a refrigerant and configured to convert the refrigerant into vapor by boiling the refrigerant therein, a high-temperature portion located inside the sealed chamber and configured to boil the refrigerant, and a heating portion located outside the sealed chamber and configured to generate heat, a vacuum pump connected to the sealed chamber and configured to lower pressure inside the sealed chamber by discharging the vapor into an atmosphere, a refrigerant tank containing a supplementary refrigerant, and a refrigerant transfer portion configured to supply the supplementary refrigerant from the refrigerant tank into the sealed chamber, wherein the high-temperature portion is configured to receive heat generated from the heating portion and directly transfer heat to the refrigerant in the sealed chamber.

### CROSS-REFERENCE TO RELATED APPLICATIONS

This application claims the benefit of Korean Patent Application No. 10-2023-0068073 filed on May 26, 2023, in the Korean Intellectual Property Office, the entire disclosure of which is incorporated herein by reference for all purposes.

### BACKGROUND

### 1. Field of the Invention

One or more embodiments relate to a low-pressure boiling cooling system.

### 2. Description of the Related Art

Various techniques have been commonly developed and used to remove heat in a system. The typical examples are a brine cycle using a single-phase flow of a refrigerant and a refrigerating cycle using a phase change of a refrigerant. Such a system has a structure in which heat generated from a heat source is finally discharged to the atmosphere or water through a heat sink such as a radiator or a condenser. In addition, a refrigerant that transfers heat in the system is recycled while circulating in the system.

The amount of heat discharged to the atmosphere is determined by the temperature difference between a refrigerant and the atmosphere, a heat transfer coefficient, and an area. The larger the temperature difference between a refrigerant and the atmosphere, the better, but due to limitations such as the temperature of a heat source, the compression limit of a compressor, and the refrigerant pressure, the temperature difference between the refrigerant and atmosphere may not be arbitrarily increased. In addition, a high-performance cooling fan and an optimal fin-pitch arrangement may be applied to a method of improving a convective heat transfer coefficient. However, it is difficult to expect a dramatic improvement in performance as the related technology has already reached maturity. That is, in a cooling system using a cycle, the heating performance may increase by increasing the area of a heat sink, but space and weight limitations exist in most cases.

However, the description above is mainly used when designing a system that continuously discharges a large amount of heat for a long time. In a system in which a large amount of heat is instantaneously generated but not in normal times, the capacity of a cooling device may be reduced by considering a cooling device to which a thermal buffer is applied. Research is being conducted on a system that may respond to an instantaneous heat load even when the cooling capacity itself is reduced by utilizing a thermal buffer (a phase change material, a cooling system, etc.) only in a situation in which a thermal load of a system is large.

However, this system may also be applied when a ratio (a duty ratio) of the operating:non-operating time is small, but it has a disadvantage that the limit is clear when the duty ratio increases. Accordingly, it is necessary to develop technology capable of miniaturizing a cooling device even when the duty ratio is large.

Current cooling technologies require a large volume to discharge heat to the air, and accordingly, there is a problem that the total volume of a system increases. However, although the amount of heat generated in many systems continues to increase recently, the demand for system compactness is also increasing.

In addition, since a heat exchanger and a cooling fan are exposed to the outside for cooling, there is a concern about damage due to the external impact and there is a problem in that the possibility of exposure increases due to noise and heat.

Patent Registration No. 10-0153721 discloses an engine cooling device for a vehicle.

### SUMMARY

Embodiments provide a low-pressure boiling cooling system capable of efficiently removing a large amount of heat by reducing the volume and weight of a cooling system by removing or reducing a radiator or a condenser compared to the cycle system according to the related art.

Embodiments provide a low-pressure boiling cooling system capable of preventing damage to a cooling system due to external impact and greatly reducing the possibility of exposure due to noise and high heat since only an exhaust duct with a small size is required.

In the present disclosure, to overcome the limitations of the cooling technology according to the related art, a phenomenon in which a refrigerant absorbs a large amount of heat during a phase change is used. That is, the phase change of the refrigerant in the cycle method according to the related art is used only to transfer a large amount of heat to a heat sink and the refrigerant that finally discharges heat through a heat exchange with the atmosphere in a large heat sink is recovered, but in the present disclosure, a large heat sink is not required by fundamentally removing a refrigerant that is phase-changed into a gas from a system.

According to an aspect, there is provided a low-pressure boiling cooling system including a sealed chamber containing a refrigerant and configured to convert the refrigerant into vapor by boiling the refrigerant therein, a high-temperature portion located inside the sealed chamber and configured to boil the refrigerant, a heating portion located outside the sealed chamber and configured to generate heat, a vacuum pump connected to the sealed chamber and configured to lower pressure inside the sealed chamber by discharging the vapor into an atmosphere, a refrigerant tank containing a supplementary refrigerant, and a refrigerant transfer portion configured to supply the supplementary refrigerant from the refrigerant tank into the sealed chamber. The high-temperature portion is configured to receive heat generated from the heating portion and directly transfer heat to the refrigerant in the sealed chamber.

The high-temperature portion may be formed by connecting a tube-shaped heat transfer duct, and the heating portion may be disposed between both end portions of the high-temperature portion.

The high-temperature portion may be formed in a shape in which heat pipes are spaced apart from each other at a predetermined interval, and the heating portion may be formed of a plurality of heating elements, wherein each heating element is connected to a corresponding heat pipe.

The heating portion and the high-temperature portion may be connected to each other through a brine cycle. The brine cycle may include a brine tank disposed between one end portion of the high-temperature portion and the heating portion. The one end portion of the high-temperature portion may be connected to the heating portion through the brine tank and the other end portion of the high-temperature portion may be directly connected to the heating portion.

The heating portion and the high-temperature portion may be connected to each other through a brine cycle and a refrigerating cycle. The brine cycle and the refrigerating cycle may be connected to each other through a heat exchanger. The brine cycle may include a brine tank disposed between one end portion of the heat exchanger and the heating portion. The one end portion of the heat exchanger may be connected to the heating portion through the brine tank and the other end portion of the heat exchanger may be directly connected to the heating portion. The refrigerating cycle may include an expansion valve disposed between one end portion of the high-temperature portion and the one end portion of the heat exchanger and a compressor disposed between the other end portion of the high-temperature portion and the other end portion of the heat exchanger. The one end portion of the high-temperature portion may be connected to the one end portion of the heat exchanger through the expansion valve and the other end portion of the high-temperature portion may be connected to the other end portion of the heat exchanger through the compressor.

The low-pressure boiling cooling system may further include a calculator configured to calculate an amount of the vapor discharged from the sealed chamber through the vacuum pump. The calculator may be configured to supply the supplementary refrigerant from the refrigerant tank into the sealed chamber through the refrigerant transfer portion by an amount corresponding to the amount of the vapor discharged from the sealed chamber.

The low-pressure boiling cooling system may further include a water level measurement sensor configured to measure a water level of the refrigerant inside the sealed chamber. The refrigerant transfer portion may be configured to control an amount of the supplementary refrigerant supplied from the refrigerant tank when the water level of the refrigerant measured by the water level measurement sensor is out of a predetermined reference value.

The sealed chamber may be provided in a plurality, includes an intake duct connecting each sealed chamber and the vacuum pump, and be individually configured to control an amount of the supplementary refrigerant supplied by an amount corresponding to an amount of vapor in each sealed chamber.

The refrigerant transfer portion may be a pump or a valve capable of adjusting a flow rate and be individually configured to control the water level of the refrigerant in the sealed chamber.

The low-pressure boiling cooling system may further include an exhaust duct connected to a rear end portion of the vacuum pump and configured to discharge the vapor into an atmosphere. The exhaust duct may include a heat transfer medium configured to change some of the vapor exhausted from the vacuum pump into a liquid phase and a refrigerant recovery path capable of recovering a refrigerant in a liquid phase to the refrigerant tank. The refrigerant recovery path may be configured to collect the refrigerant in the liquid phase from the exhaust duct and recover the refrigerant in the liquid phase to the refrigerant tank or the sealed chamber.

The refrigerant may be water. The low-pressure boiling cooling system may further include a hydrogen fuel cell configured to supply driving power and a water discharge path configured to supply water generated from the hydrogen fuel cell to the exhaust duct. The low-pressure boiling cooling system may be configured to recover the water supplied to the exhaust duct through water discharge path to the refrigerant tank or the sealed chamber through the refrigerant recovery path and raise a temperature of the refrigerant by transferring waste heat generated by driving the hydrogen fuel cell to the high-temperature portion.

The low-pressure boiling cooling system may further include an opening and closing valve located between the refrigerant tank and the refrigerant transfer portion. The refrigerant tank may be configured to be detachable in a state in which the opening and closing valve is closed. The opening and closing valve may be formed of a single opening and closing valve or a plurality of opening and closing valves.

The low-pressure boiling cooling system may further include a partition wall configured to suppress horizontal movement of the refrigerant by vertically being formed up to a location higher than a water level of the refrigerant inside the sealed chamber. The refrigerant transfer portion may have a plurality of supply pipes connected to each space divided by the partition wall to supply the supplementary refrigerant to each space divided by the partition wall.

The low-pressure boiling cooling system may further include a heater installed inside or outside the sealed chamber or inside or outside the refrigerant tank. The heater may operate to prevent freezing and bursting in the sealed chamber or the refrigerant tank due to a volume change at a low temperature. The refrigerant transfer portion may be configured to circulate the refrigerant in the sealed chamber or the supplementary refrigerant in the refrigerant tank of which temperature rises through the heater.

The low-pressure boiling cooling system may further include a perforation located on one side of an intake duct connecting the sealed chamber and the vacuum pump and capable of introducing external air and an intake valve with a variable opening amount capable of adjusting an amount of the external air introduced into the perforation. The low-pressure boiling cooling system may be configured to lower an output of the vacuum pump by opening the intake valve with a variable opening amount and inhaling the external air to maintain a degree of vacuum inside the sealed chamber.

Additional aspects of embodiments will be set forth in part in the description which follows and, in part, will be apparent from the description, or may be learned by practice of the disclosure.

According to embodiments, a low-pressure boiling cooling system may efficiently remove a large amount of heat by reducing the volume and weight of a cooling system by removing or reducing a radiator or a condenser compared to the cycle system according to the related art.

According to embodiments, since a low-pressure boiling cooling system requires only an exhaust duct with a small size, damage to a cooling system due to external impact may be prevented and the possibility of exposure due to noise and high heat may be greatly reduced.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram schematically illustrating the overall structure of a low-pressure boiling cooling system according to an embodiment;

FIG. 2 is a diagram schematically illustrating a structure in which a high-temperature portion of the low-pressure boiling cooling system includes heat pipes, according to an embodiment;

FIG. 3 is a diagram schematically illustrating a structure in which the low-pressure boiling cooling system and a heating portion are connected to each other by a brine cycle, according to an embodiment;

FIG. 4 is a diagram schematically illustrating a structure in which the low-pressure boiling cooling system is connected to the brine cycle and a refrigerating cycle, according to an embodiment;

FIG. 5 is a diagram schematically illustrating a structure in which a sealed chamber is provided in a plurality, according to an exemplary embodiment;

FIG. 6 is a diagram schematically illustrating a structure in which partition walls are formed inside the sealed chamber, according to an embodiment;

FIG. 7 is a diagram schematically illustrating a structure in which vapor in the exhaust duct is recovered to a refrigerant tank through a refrigerant recovery path, according to an embodiment;

FIG. 8 is a diagram illustrating a structure in which water generated from a hydrogen fuel cell is recovered to the refrigerant tank, according to an embodiment; and

FIG. 9 is a diagram schematically illustrating a structure in which a vacuum pump is driven by a waterring vacuum pump, according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

The same name may be used to describe an element included in the example embodiments described above and an element having a common function. Unless otherwise mentioned, the descriptions on the embodiments may be applicable to the following embodiments and thus, duplicated descriptions will be omitted for conciseness.

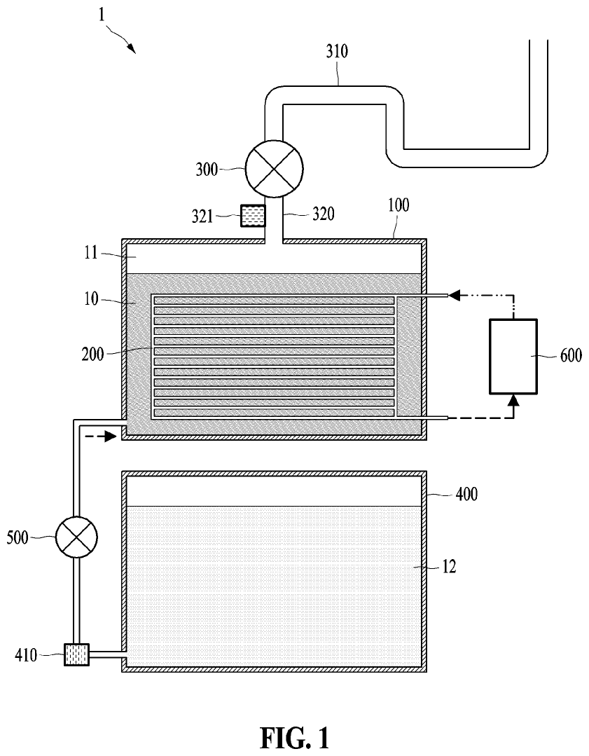

FIG. 1 is a diagram schematically illustrating the overall structure of a low-pressure boiling cooling system 1 according to an embodiment.

Referring to FIG. 1, according to an embodiment, the low-pressure boiling cooling system 1 is a cooling system using a phenomenon in which the boiling point of a refrigerant is lowered when pressure is lowered and may include a sealed chamber 100 containing a refrigerant 10 and configured to convert the refrigerant 10 into vapor 11 by boiling the refrigerant 10 therein, a high-temperature portion 200 located inside the sealed chamber 100 and configured to boil the refrigerant 10, a heating portion 600 located outside the sealed chamber 100 and configured to generate heat, a vacuum pump 300 connected to the sealed chamber 100 and configured to lower the boiling point of the refrigerant 10 by discharging the vapor 11 into the atmosphere and lowering pressure inside the sealed chamber 100, a refrigerant tank 400 containing a supplementary refrigerant 12, and a refrigerant transfer portion 500 configured to supply the supplementary refrigerant 12 from the refrigerant tank 400 into the sealed chamber 100.

Specifically, when the boiling point of the refrigerant 10 in the sealed chamber 100 is lower than the temperature of the high-temperature portion 200, the refrigerant 10 may be changed to the vapor 11 while receiving heat from the high-temperature portion 200 and undergoing a phase change. Since the internal pressure of the sealed chamber 100 rises due to the continuously generated vapor 11, the vapor 11 generated by the phase change must be removed from the sealed chamber 100 through the vacuum pump 300 to continuously remove heat from the high-temperature portion 200. The amount of the supplementary refrigerant 12 corresponding to the amount removed as the vapor 11 may be supplied from the refrigerant tank 400 through the refrigerant transfer portion 500, and since the amount of supplementary refrigerant 12 supplied into the sealed chamber 100 from the refrigerant transfer portion 500 is significantly smaller than the volume of the refrigerant 10 inside the sealed chamber 100, the flow rate is slow, and the convection due to boiling of flow inside the sealed chamber 100 is absolute, the boiling phenomenon inside the sealed chamber 100 may be regarded as pool boiling.

According to an embodiment, the low-pressure boiling cooling system 1 is a cooling system using a phenomenon in which the boiling point is lowered when pressure is lowered, for example, the boiling point may be around 60° C. at the 0.2 atmospheric pressure level and may be around 50° C. at the 0.1 atmospheric pressure level. Here, even when the boiling point is lowered, the latent heat due to a phase change may not be changed significantly.

In addition, in the atmospheric pressure environment, the heat transfer performance may be greatly improved until the difference between the boiling point of the refrigerant 10 and the temperature of the high-temperature portion 200 reaches about 30K, and a value of the boiling point may be slightly changed in the low-pressure environment, but the tendency may be maintained.

In addition, pre-conditioning may be performed so that the temperature inside the sealed chamber 100 is lower than the temperature of the high-temperature portion 200. Here, since the boiling point may be freely changed according to the internal pressure formed by the vacuum pump 300 in a state in which the temperature inside the sealed chamber 100 is higher than the temperature of the high-temperature portion 200, the pre-conditioning may mean that the temperature inside the sealed chamber 100 is set in advance to be lower than or equal to the temperature of the high-temperature portion 200. For example, in a state in which the boiling point of the sealed chamber 100 is set to 50° C. through pressure control of the vacuum pump 300, when the temperature inside the sealed chamber 100 is 40° C., water may not be boiled. Here, when a fluid with a temperature of 60° C. is supplied to the high-temperature portion 200, the difference between the temperature of the high-temperature portion 200 and the temperature inside the sealed chamber 100 may become 20° C., and since the temperature of the high-temperature portion 200 is higher than the boiling point of the sealed chamber 100, the refrigerant 10 in contact with a surface of the high-temperature portion 200 may be changed to the vapor 11 while boiling.

As described later, the high-temperature portion 200 may directly supply heat to the inside of the sealed chamber 100 like a heat pipe 210 and may also be a device that receives heat from the heating portion 600 and discharges the heat. In addition, a fluid flowing inside the high-temperature portion 200 and the heating portion 600 may have a circuit independent of the refrigerant 10 inside the sealed chamber 100.

In addition, when the amount of the vapor 11 generated per hour is removed from the vacuum pump 300, the low pressure may be maintained and the boiling point may also be maintained so that a full boiling state in which heat from the high-temperature portion 200 is removed while the refrigerant 10 continuously boils may continue. However, when this state continues, the temperature of the refrigerant 10 that does not contact the high-temperature portion 200 inside the sealed chamber 100 may also rise due to the conduction and convection of the refrigerant 10 and eventually the overall temperature of the refrigerant 10 may become the same as the boiling point. That is, in this case, the difference between the temperature of the high-temperature portion 200 and the temperature inside the sealed chamber 100 may be less than the pre-conditioned temperature difference, and the heat transfer performance may be reduced compared to the initial one. Accordingly, it may be advantageous for the high-temperature portion 200 to have a sufficient surface area to satisfy the heat radiation performance even in such an environment.

In addition, due to the characteristics of using boiling, since the heat transfer coefficient of the refrigerant 10 on the surface of the high-temperature portion 200 is high, the need to densely dispose a plurality of heat transfer ducts is low and a form in which a single heat transfer duct or a plurality of heat transfer ducts are connected to each other may also be suitable for the high-temperature portion 200. In addition, fine roughness may be provided because the surface of the high-temperature portion 200 with slight roughness is advantageous for the bubble formation and further promotes the boiling phenomenon, and to this end, patterning, partial corrosion, grinding, coating, etc. may be applied to the surface of the high-temperature portion 200. In addition, both methods of disposing the pipe shape horizontally and vertically are possible, but as the depth of water increases, the pressure increases and the boiling point of the refrigerant 10 rises, so the capacity of the vacuum pump 300 must increase and accordingly, it is advantageous to have a shallow depth of water. That is, since the shallow and wide sealed chamber (i.e., the sealed chamber 100) is advantageous, a method of disposing the pipe shape horizontally may be advantageous.

The vacuum pump 300 may be connected to an exhaust duct 310 and discharge the vapor 11 into the atmosphere and may be connected to an intake duct 320 and absorb the vapor 11 inside the sealed chamber 100.

In addition, the vacuum pump 300 may be driven with an output higher than the output for achieving the target degree of vacuum inside the sealed chamber 100, or the target degree of vacuum inside the sealed chamber 100 may be generated at an output lower than the minimum value of the output of the vacuum pump 300. Accordingly, according to an embodiment, a perforation (not shown) may be located on one side of the intake duct 320, and an intake valve 321 with a variable opening amount may adjust the amount of external air introduced into the perforation. That is, to maintain the degree of vacuum inside the sealed chamber 100, the intake valve 321 with a variable opening amount may be opened and external air is partially inhaled, so the effect of lowering the output of the vacuum pump 300 may be possible.

The refrigerant transfer portion 500 may be a pump or a valve capable of adjusting the flow rate, and since the boiling amount of the refrigerant 10 is determined according to the amount of heat, the refrigerant transfer portion 500 may be controlled by continuously supplying a certain amount of the supplementary refrigerant 12 to the sealed chamber 100. In addition, a calculator (not shown) configured to calculate the amount of the vapor 11 inside the sealed chamber 100 may be further included, and the calculator may supply the supplementary refrigerant 12 from the refrigerant tank 400 into the sealed chamber 100 through the refrigerant transfer portion 500 by an amount corresponding to the amount of the vapor 11.

In addition, when there is a water level measurement sensor (not shown) configured to measure a water level of the refrigerant 10 inside the sealed chamber 100, when the water level of the refrigerant 10 measured by the water level measurement sensor is out of a predetermined reference value, the refrigerant transfer portion 500 may adjust the amount of the supplementary refrigerant 12 supplied from the refrigerant tank 400.

In addition, even when there is no refrigerant transfer portion 500, when the water level inside the refrigerant tank 400 is higher than the water level inside the sealed chamber 100, the supplementary refrigerant 12 may naturally flow into the sealed chamber 100 from the refrigerant tank 400. Accordingly, the refrigerant tank 400 may be installed so that the location of the water level inside the refrigerant tank 400 is higher than the water level inside the sealed chamber 100. Here, the refrigerant transfer portion 500 is a valve capable of adjusting the flow rate of the supplementary refrigerant 12 and may supply the supplementary refrigerant 12 to the sealed chamber 100 by adjusting the amount of opening.

The refrigerant 10 inside the sealed chamber 100 and the supplementary refrigerant 12 inside the refrigerant tank 400 may correspond to the same material, and the refrigerant 10 and the supplementary refrigerant 12 may be water. However, this is only an example, and from the perspective of one of ordinary skill in the art, it is obvious that the types of the refrigerant 10 and the supplementary refrigerant 12 may be selectively changed as needed. For example, a material having characteristics of a liquid phase in the atmospheric pressure environment, high latent heat, a slightly high temperature around 50° C., or a non-toxic material when discharged into the atmosphere may be used.

According to an embodiment, an opening and closing valve 410 may be located between the refrigerant tank 400 and the refrigerant transfer portion 500 and the refrigerant tank 400 may be detachable in a state in which the opening and closing valve 410 is closed. That is, after the supplementary refrigerant 12 inside the refrigerant tank 400 is exhausted, the operation of a system is inevitably stopped and the refrigerant tank 400 may be replaced through the opening and closing valve 410 to which the refrigerant tank 400 may be accessed when all the supplementary refrigerant 12 of the refrigerant tank 400 is exhausted.

In addition, according to an embodiment, the opening and closing valve 410 may be provided in a plurality or a flow path in the opening and closing valve 410 may be provided in a plurality, and the plurality of refrigerant tanks 400 may be connected to the plurality of opening and closing valves 410 or the plurality of flow paths in the opening and closing valve 410.

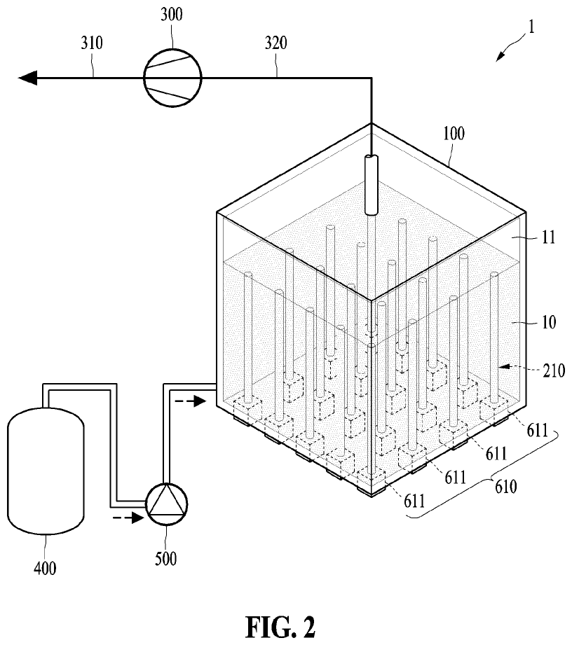

FIG. 2 is a diagram schematically illustrating a structure in which the high-temperature portion 200 of the low-pressure boiling cooling system 1 includes heat pipes 210, according to an embodiment.

According to an embodiment, as shown in FIG. 2, the high-temperature portion 200 may be a single tube-shaped heat pipe 210 or a plurality of tube-shaped heat pipes 210 and the heating portion 600 may be a heating element package 610 including a single heating element 611 or a plurality of heating elements 611. In addition, according to an embodiment, a fine uneven portion may be formed on a surface of the heat pipe 210 to improve the heat transfer performance.

Specifically, when the heating portion 600 is a bundle of heating elements 611 that generate a large amount of heat although the bundle is small, that is, the heating element package 610, the heating elements 611, which are basic heat source units, are generally disposed in series and the heating elements 611 disposed in series and one cooling circuit panel (not shown) are fastened to each other to form a single module. In addition, heat from the heating element 611 may be absorbed and transferred while a fluid such as water flows into a cooling circuit formed inside the cooling circuit panel, so the heating element package 610 may be formed by connecting several single modules in parallel. That is, when the heating portion 600 is the heating element package 610, the heating element 611, which is a basic heat source unit, may be provided in a plurality and a plurality of brine channels may be configured in series or parallel. Here, the heating element 611 may be a power element.

The heat pipe 210 may be applied to this system, and the heat pipe 210 may be fastened to the heating element 611, which is a basic heat source unit. In addition, the ratio between the heating element 611 and the heat pipe 210 may be 1:1 or M:N (here, M and N refer to arbitrary integers) or may be variable according to design. In addition, the heat pipe 210 may be disposed in a plurality inside the sealed chamber 100 by passing through one side of the sealed chamber 100.

Here, since the performance of the heat pipe 210 is affected by gravity, to maximize the effect, when the heating element package 610 is at a lower part of the sealed chamber 100 and the heat pipe 210 is fastened to an upper part of the heating element package 610, a fluid inside the heat pipe 210 that receives heat may be vaporized and rise upwardly and a fluid cooled by contact with the refrigerant 10 inside the sealed chamber 100 may descend downwardly due to gravity and a capillary phenomenon in the wick and repeatedly transfer heat.

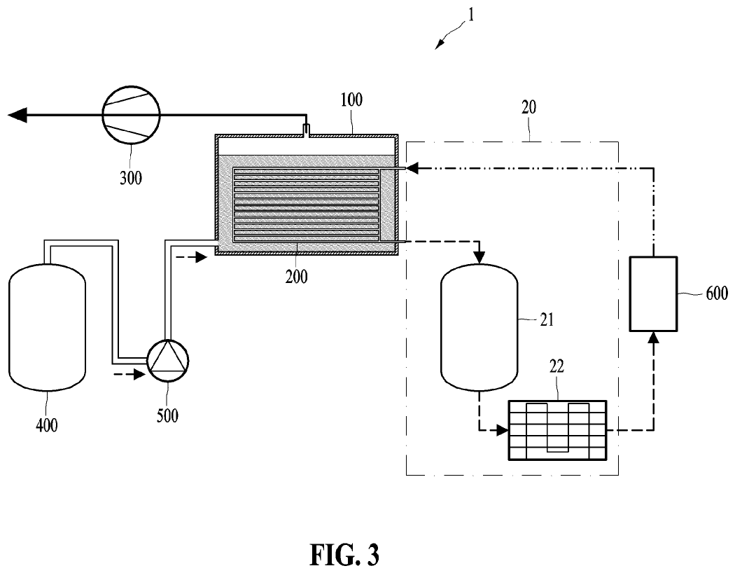

FIG. 3 is a diagram schematically illustrating a structure in which the low-pressure boiling cooling system 1 and the heating portion 600 are connected to each other by a brine cycle 20, according to an embodiment.

The heating portion 600 does not necessarily have to be a single one, and various heating portions 600 may be connected in series or parallel.

According to an embodiment, as shown in FIG. 3, the heating portion 600 and the high-temperature portion 200 may be connected to each other through the brine cycle 20. Specifically, when the temperature of the heating portion 600 is sufficiently high (e.g., when the temperature of the heating portion 600 is 50° C. or higher), heat may be transferred to the high-temperature portion 200 through the brine cycle 20 that absorbs heat generated from the heating portion 600 and discharges the heat through a radiator.

In addition, when the heating portion 600 is sensitive to temperature, a brine tank 21 for a thermal buffer purpose may be included, and since the temperature of a fluid passing through the inside of the sealed chamber 100 rises, a brine radiator 22 may be installed to remove sensible heat and the disposition order of the brine tank 21 and the brine radiator 22 may be changed. Here, one end portion of the high-temperature portion 200 may be connected to the heating portion 600 through the brine tank 21 and the brine radiator 22 and the other end portion of the high-temperature portion 200 may be directly connected to the heating portion 600.

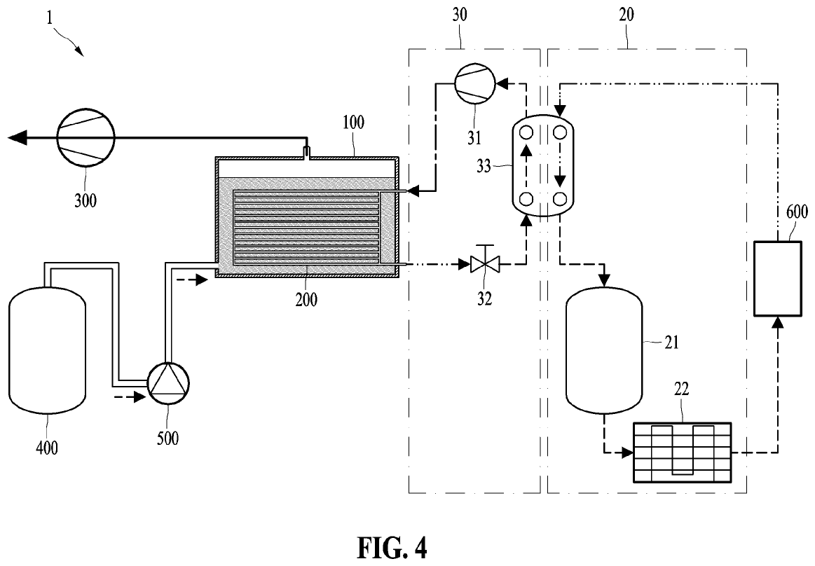

FIG. 4 is a diagram schematically illustrating a structure in which the low-pressure boiling cooling system 1 is connected to the brine cycle 20 and a refrigerating cycle 30, according to an embodiment.

As the pressure inside the sealed chamber 100 decreases, the volume per unit mass of the vapor 11 increases exponentially, so the capacity of the vacuum pump 300 also needs to increase exponentially. That is, to reduce the capacity of the vacuum pump 300, it is advantageous when the low-pressure boiling cooling system 1 may operate even when the pressure inside the sealed chamber 100 is high, which means that it is advantageous when the temperature of the high-temperature portion 200 is high. However, when heat needs to be discharged into the atmosphere even when the temperature of the heating portion 600 is low, configuring the refrigerating cycle 30 in which the temperature of a refrigerant is higher than the temperature of the atmosphere using a compressor 31 and then heat is discharged into the atmosphere through a condenser may be advantageous because the capacity of the vacuum pump 300 is reduced.

Accordingly, referring to FIG. 4, in the case of a system in which the temperature of the heating portion 600 is low, the refrigerating cycle 30 may be further included in a heat transfer path between the high-temperature portion 200, which is installed inside the sealed chamber 100, and the heating portion 600. That is, the temperature of heat generated from the heating portion 600 is raised through the compressor 31 and the refrigerating cycle 30 that radiates heat in the high-temperature portion 200 may be connected to the low-pressure boiling cooling system 1 by a fluid changed to a high-temperature and a high-pressure fluid in the compressor 31, and here, the high-temperature portion 200 may serve as a condenser in the refrigerating cycle 30.

Specifically, as shown in FIG. 4, the heating portion 600 and the high-temperature portion 200 may be connected to each other through the brine cycle 20 and the refrigerating cycle 30, and the brine cycle 20 and the refrigerating cycle 30 may be connected to each other through a heat exchanger 33. The brine cycle 20 may include the brine tank 21 disposed between one end portion of the heat exchanger 33 and the heating portion 600 and the brine radiator 22 disposed between the brine tank 21 and the heating portion 600, and one end portion of the heat exchanger 33 may be connected to the heating portion 600 through the brine tank 21 and the brine radiator 22 and the other end portion of the heat exchanger 33 may be directly connected to the heating portion 600. In addition, the refrigerating cycle 30 may include an expansion valve 32 disposed between one end portion of the high-temperature portion 200 and one end portion of the heat exchanger 33 and the compressor 31 disposed between the other end portion of the high-temperature portion 200 and the other end portion of the heat exchanger 33, and one end portion of the high-temperature portion 200 may be connected to one end portion of the heat exchanger 33 through the expansion valve 32 and the other end portion of the high-temperature portion 200 may be connected to the other end portion of the heat exchanger 33 through the compressor 31.

Since the R-410A refrigerant and R-134A refrigerant that are commonly used may be used at a condensation temperature of 60° C. to 80° C., when the temperature of the heating portion 600 is low, the volume and weight of the low-pressure boiling cooling system 1 may be reduced by adding the refrigerating cycle 30 instead of a method of increasing the capacity of the vacuum pump 300.

In addition, when the refrigerating cycle 30 is applied to the low-pressure boiling cooling system 1, the brine radiator 22 may serve as the heat exchanger 33. That is, a structure in which the refrigerating cycle 30 absorbs both the heat from the heating portion 600 and the heat from the brine radiator 22, the heat is transferred to the sealed chamber 100, and then the vacuum pump 300 takes the heat out may be applied to the low-pressure boiling cooling system 1.

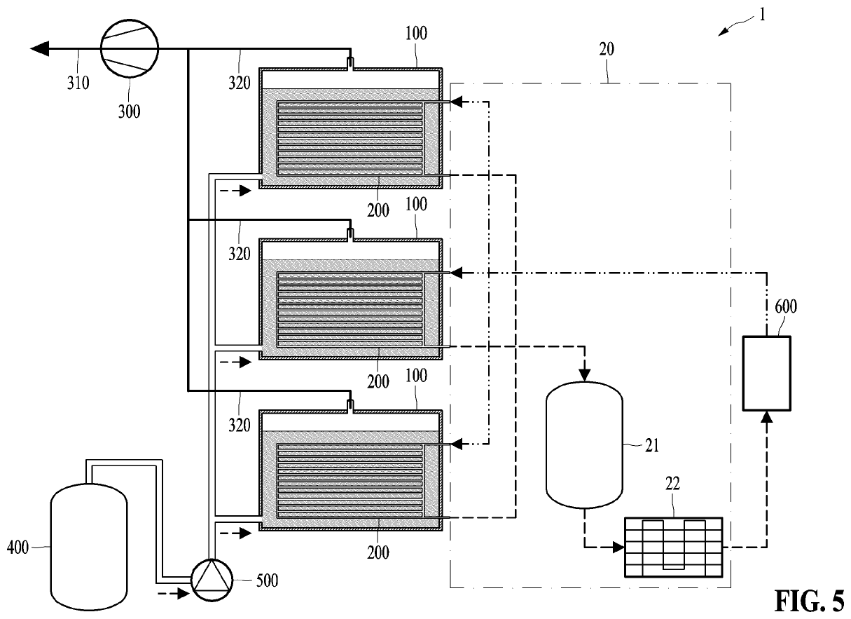

FIG. 5 is a diagram schematically illustrating a structure in which the sealed chamber 100 is provided in plurality, according to an embodiment.

According to an embodiment, as shown in FIG. 5, the sealed chamber 100 may be provided in plurality and the intake duct 320 connecting the plurality of sealed chambers 100 and the vacuum pump 300 may be provided in plurality. When the sealed chamber 100 has a shallow and wide shape, since the depth of water for each area of the sealed chamber 100 may greatly vary depending on the horizontality of the low-pressure boiling cooling system 1 when a vehicle is tilted, the sealed chamber 100 may be provided in plurality in a system that needs to remove a large amount of heat.

As the depth of water increases, the pressure increases and the boiling point of the refrigerant 10 rises, so the capacity of the vacuum pump 300 must increase and accordingly, it may be advantageous to have a shallow depth of water. That is, since the shallow and wide sealed chamber 100 is advantageous, the shallow and wide sealed chamber 100 may be provided in plurality.

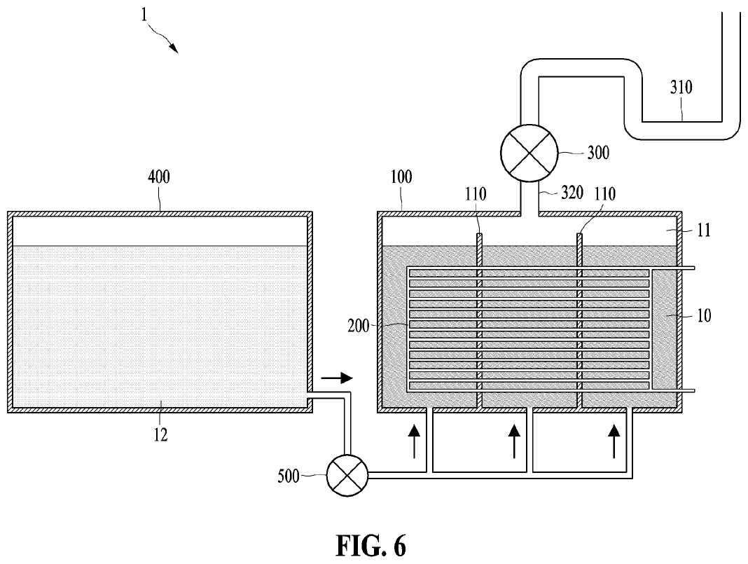

FIG. 6 is a diagram schematically illustrating a structure in which partition walls 110 are formed inside the sealed chamber 100, according to an embodiment.

According to an embodiment, as shown in FIG. 6, the change in the depth of water may be minimized by installing the partition wall 110 formed vertically up to a location higher than the depth of water of the refrigerant 10 inside the sealed chamber 100 and suppressing the horizontal movement of the refrigerant 10 filled inside the sealed chamber 100 according to the slope.

In addition, according to an embodiment, a supply pipe connected to each space divided by the partition wall 110 may be provided in plurality so that the refrigerant transfer portion 500 supplies the supplementary refrigerant 12 to each space divided by the partition wall 110.

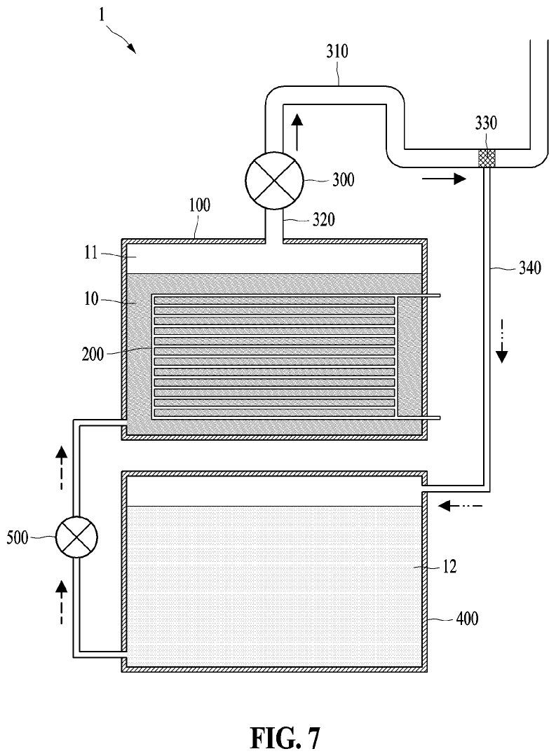

FIG. 7 is a diagram schematically illustrating a structure in which the vapor 11 in the exhaust duct 310 is recovered to the refrigerant tank 400 through a refrigerant recovery path 340, according to an embodiment.

As shown in FIG. 7, according to an embodiment, the low-pressure boiling cooling system 1 may further include the exhaust duct 310 connected to a rear end portion of the vacuum pump 300 and discharging the vapor 11 into the atmosphere.

Most of the vapor 11 exiting through the vacuum pump 300 exits while maintaining a gaseous phase, but some of the vapor 11 may be changed to a liquid phase with only slight cooling due to the insufficient degree of overheat. Accordingly, the exhaust duct 310 may include a heat transfer medium 330 that changes some of the vapor 11 exhausted from the vacuum pump 300 to a liquid phase, and here, a refrigerant in a liquid phase may be recovered to the refrigerant tank 400 or the sealed chamber 100 by connecting the refrigerant recovery path 340 to the heat transfer medium 330. Here, the heat transfer medium 330 may be a heat transfer fin or a radiator having a large contact area.

According to an embodiment, the exhaust duct 310 may be formed in an uneven or concave shape and allow a refrigerant in a liquid phase to gather and stagnate. In addition, the exhaust duct 310 may be formed of a material such as aluminum having good heat transfer and allow the vapor 11 to convert into a liquid phase through contact with the exhaust duct 310.

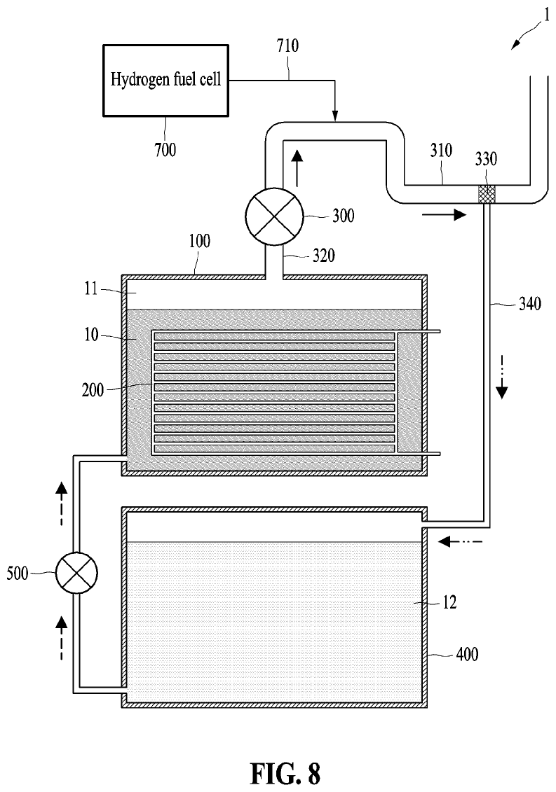

FIG. 8 is a diagram illustrating a structure in which water generated from a hydrogen fuel cell 700 is recovered to the refrigerant tank 400, according to an embodiment.

According to an embodiment, as shown in FIG. 8, the refrigerant 10 is water, the hydrogen fuel cell 700 may be used to supply driving power and water generated from the hydrogen fuel cell 700 may be collected and recovered to the refrigerant tank 400 or the sealed chamber 100. When the low-pressure boiling cooling system 1 is driven, water may be continuously consumed, and thus, water must be continuously supplied from outside. Here, since the hydrogen fuel cell 700 generates energy and discharges water as a by-product, the water may be recovered to the refrigerant tank 400.

Specifically, the water discharged from the hydrogen fuel cell 700 may be a mixture of gaseous and liquid phases, and water vapor may be changed to a liquid phase through the heat transfer medium 330 and the water in a liquid phase may be recovered to the refrigerant tank 400 through the refrigerant recovery path 340.

According to an embodiment, the low-pressure boiling cooling system 1 may further include a water discharge path 710 to supply water from the hydrogen fuel cell 700 to the exhaust duct 310.

In addition, according to an embodiment, the low-pressure boiling cooling system 1 may serve as an anti-freezing and bursting heater by transferring waste heat generated while driving the hydrogen fuel cell 700 to the high-temperature portion 200 and raising the temperature of the refrigerant 10.

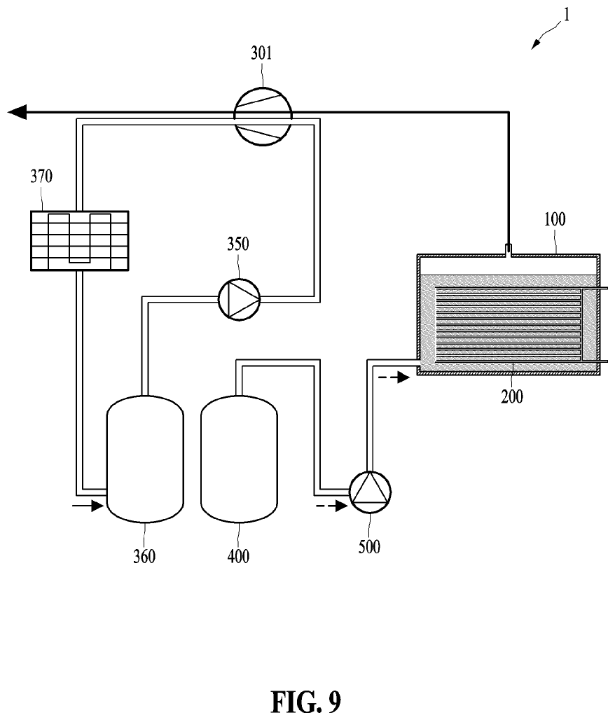

FIG. 9 is a diagram schematically illustrating a structure in which the vacuum pump 300 is driven by a waterring vacuum pump 301, according to an embodiment.

Referring to FIG. 9, the vacuum pump 300 may be the waterring vacuum pump 301 using the centrifugal force of water because it is necessary to continuously remove a large amount of water vapor at the target pressure.

According to an embodiment, the supplementary refrigerant 12 may correspond to water and water may be supplied from the refrigerant tank 400 to the waterring vacuum pump 301.

According to an embodiment, a vacuum pump radiator 370 may be further included to reduce the temperature of water of which temperature rises while passing through the waterring vacuum pump 301.

Water must be supplied to the waterring vacuum pump 301 through a vacuum pump type water pump 350 by discharging the medium-temperature water of which temperature rises due to friction to the outside after using the water pushed outward by centrifugal force while supplying the low-temperature water like a bearing. Accordingly, a vacuum pump water tank 360 to supply separate water may be further included, the vacuum pump water tank 360 may supply the low-temperature water to the waterring vacuum pump 301 and recover the medium-temperature water to the vacuum pump water tank 360, and since the temperature must be lowered to the low temperature to recover and use the medium-temperature water again, heat may be removed through the vacuum pump radiator 370. In addition, the vacuum pump water tank 360 may be the refrigerant tank 400.

In addition, the temperature of the medium-temperature water may be lower than the upper limit of the temperature of the cooling water required by the heating portion 600, and here, the low-temperature water may pass through the waterring vacuum pump 301 and the medium-temperature water of which temperature rises may be sent to the heating portion 600, and the water passing through the heating portion 600 may become high-temperature water and pass through the inside of the high-temperature portion 200. The high-temperature water may become low-temperature water while passing through the sealed chamber 100, and the low-temperature water may be transferred to the vacuum pump water tank 360 or the refrigerant tank 400. Here, the air-cooling may be applied to the brine radiator 22 existing to send the low-temperature water to the waterring vacuum pump 301.

In addition, since water in the waterring vacuum pump 301 may function as a bearing only with sufficient centrifugal force, there may be a control limit at a low output in which there is a lower limit on the rotational speed of a pump and the degree of vacuum is not greatly required. To this end, the waterring vacuum pump 301 may be driven at the lowest controllable speed, but when an output lower than the lowest controllable speed is required, a countermeasure against a low load may be devised by intaking external air by controlling the intake duct 320 or the intake valve 321 with a variable opening amount without lowering the rotational speed.

In addition, by considering the case in which a change in the rotational speed may not be known due to the inertia of the waterring vacuum pump 301 when a rapid heat load change occurs, the waterring vacuum pump 301 may appropriately adjust the boiling point inside the sealed chamber 100 by setting an output slightly higher than the required degree of vacuum and adjusting the amount of opening amount of the intake valve 321 with a variable opening amount.

According to an embodiment, the low-pressure boiling cooling system 1 may further include a heater (not shown) installed inside or outside the sealed chamber 100 or inside or outside the refrigerant tank 400 and the heater may operate to prevent freezing and bursting in the sealed chamber 100 or the refrigerant tank 400 due to a change in volume at the low temperature. The heater may be integrally connected to the refrigerant tank 400, connected to a refrigerant tank attachment portion (not shown), or connected to one side of the sealed chamber 100.

According to an embodiment, the refrigerant transfer portion 500 may circulate the refrigerant 10 in the sealed chamber 100 or the supplementary refrigerant 12 in the refrigerant tank 400 of which temperature rises through the heater, through which the refrigerant 10 or the supplementary refrigerant 12 may be prevented from freezing and bursting.

In addition, the high-temperature portion 200 may serve as the heater by raising the temperature of the high temperature portion 200. Here, when the heating portion 600 is not used to raise the temperature of the high temperature portion 200, the temperature of the high-temperature portion 200 may be raised using a separate heat source (not shown) other than the heating portion 600.

As described above, according to an embodiment, the low-pressure boiling type cooling system 1 may efficiently remove a large amount of heat by reducing the volume and weight of a cooling system as a radiator or condenser is removed or reduced compared to the cycle system according to the related art.

According to an embodiment, since the low-pressure boiling cooling system 1 requires only the exhaust duct 310 with a small size, damage to a cooling system due to external impact may be prevented and the possibility of exposure due to noise and high heat may be greatly reduced.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A low-pressure boiling cooling system comprising:
a sealed chamber containing a refrigerant and configured to convert the refrigerant into vapor by boiling the refrigerant therein;
a high-temperature portion located inside the sealed chamber and configured to boil the refrigerant;
a heating portion located outside the sealed chamber and configured to generate heat;
a vacuum pump connected to the sealed chamber and configured to lower pressure inside the sealed chamber by discharging the vapor into an atmosphere;
a refrigerant tank containing a supplementary refrigerant; and
a refrigerant transfer portion configured to supply the supplementary refrigerant from the refrigerant tank into the sealed chamber,
wherein the high-temperature portion is configured to receive heat generated from the heating portion and directly transfer heat to the refrigerant in the sealed chamber.

2. The low-pressure boiling cooling system of claim 1, wherein
the high-temperature portion is formed by connecting a tube-shaped heat transfer duct, and
the heating portion is disposed between both end portions of the high-temperature portion.

3. The low-pressure boiling cooling system of claim 1, wherein
the high-temperature portion is formed in a shape in which heat pipes are spaced apart from each other at a predetermined interval, and
the heating portion is formed of a plurality of heating elements, wherein each heating element is connected to a corresponding heat pipe.

4. The low-pressure boiling cooling system of claim 2, wherein the heating portion and the high-temperature portion are connected to each other through a brine cycle,
wherein the brine cycle comprises a brine tank disposed between one end portion of the high-temperature portion and the heating portion, and
wherein the one end portion of the high-temperature portion is connected to the heating portion through the brine tank and the other end portion of the high-temperature portion is directly connected to the heating portion.

5. The low-pressure boiling cooling system of claim 2, wherein the heating portion and the high-temperature portion are connected to each other through a brine cycle and a refrigerating cycle,
wherein the brine cycle and the refrigerating cycle are connected to each other through a heat exchanger,
wherein the brine cycle comprises a brine tank disposed between one end portion of the heat exchanger and the heating portion,
wherein the one end portion of the heat exchanger is connected to the heating portion through the brine tank and the other end portion of the heat exchanger is directly connected to the heating portion, and
wherein the refrigerating cycle comprises:
an expansion valve disposed between one end portion of the high-temperature portion and the one end portion of the heat exchanger; and
a compressor disposed between the other end portion of the high-temperature portion and the other end portion of the heat exchanger.

6. The low-pressure boiling cooling system of claim 1, further comprising:
a calculator configured to calculate an amount of the vapor discharged from the sealed chamber through the vacuum pump,
wherein the calculator is configured to supply the supplementary refrigerant from the refrigerant tank into the sealed chamber through the refrigerant transfer portion by an amount corresponding to the amount of the vapor discharged from the sealed chamber.

7. The low-pressure boiling cooling system of claim 1, further comprising:
a water level measurement sensor configured to measure a water level of the refrigerant inside the sealed chamber,
wherein the refrigerant transfer portion is configured to control an amount of the supplementary refrigerant supplied from the refrigerant tank when the water level of the refrigerant measured by the water level measurement sensor is out of a predetermined reference value.

8. The low-pressure boiling cooling system of claim 1, wherein the sealed chamber is provided in plurality, comprises an intake duct connecting each sealed chamber and the vacuum pump, and is individually configured to control an amount of the supplementary refrigerant supplied by an amount corresponding to an amount of vapor in each sealed chamber.

9. The low-pressure boiling cooling system of claim 7, wherein the refrigerant transfer portion is a pump or a valve capable of adjusting a flow rate and is individually configured to control the water level of the refrigerant in the sealed chamber.

10. The low-pressure boiling cooling system of claim 1, further comprising:
an exhaust duct connected to a rear end portion of the vacuum pump and configured to discharge the vapor into an atmosphere,
wherein the exhaust duct comprises:
a heat transfer medium configured to change some of the vapor exhausted from the vacuum pump into a liquid phase; and
a refrigerant recovery path capable of recovering a refrigerant in a liquid phase to the refrigerant tank,
wherein the refrigerant recovery path is configured to collect the refrigerant in the liquid phase from the exhaust duct and recover the refrigerant in the liquid phase to the refrigerant tank or the sealed chamber.

11. The low-pressure boiling cooling system of claim 10, wherein the refrigerant is water,
wherein the low-pressure boiling cooling system further comprises:
a hydrogen fuel cell configured to supply driving power; and
a water discharge path configured to supply water generated from the hydrogen fuel cell to the exhaust duct,
wherein the low-pressure boiling cooling system is configured to:
recover the water supplied to the exhaust duct through water discharge path to the refrigerant tank or the sealed chamber through the refrigerant recovery path; and
raise a temperature of the refrigerant by transferring waste heat generated by driving the hydrogen fuel cell to the high-temperature portion.

12. The low-pressure boiling cooling system of claim 1, further comprising:
an opening and closing valve located between the refrigerant tank and the refrigerant transfer portion,
wherein the refrigerant tank is configured to be detachable in a state in which the opening and closing valve is closed, and
wherein the opening and closing valve is formed of a single opening and closing valve or a plurality of opening and closing valves.

13. The low-pressure boiling cooling system of claim 1, further comprising:
a partition wall configured to suppress horizontal movement of the refrigerant by vertically being formed up to a location higher than a water level of the refrigerant inside the sealed chamber,
wherein the refrigerant transfer portion has a plurality of supply pipes connected to each space divided by the partition wall to supply the supplementary refrigerant to each space divided by the partition wall.

14. The low-pressure boiling cooling system of claim 1, further comprising:
a heater installed inside or outside the sealed chamber or inside or outside the refrigerant tank,
wherein the heater operates to prevent freezing and bursting in the sealed chamber or the refrigerant tank due to a volume change at a low temperature, and
wherein the refrigerant transfer portion is configured to circulate the refrigerant in the sealed chamber or the supplementary refrigerant in the refrigerant tank of which temperature rises through the heater.

15. The low-pressure boiling cooling system of claim 1, further comprising:
a perforation located on one side of an intake duct connecting the sealed chamber and the vacuum pump and capable of introducing external air; and
an intake valve with a variable opening amount capable of adjusting an amount of the external air introduced into the perforation,
wherein the low-pressure boiling cooling system is configured to lower an output of the vacuum pump by opening the intake valve with a variable opening amount and inhaling the external air to maintain a degree of vacuum inside the sealed chamber.
